(19) United States
(12) Patent Application Publication
(10) Pub. No.: US 2011/0318166 A1
(43) Pub. Date: Dec. 29, 2011

(54) Pulsation Damper Element for a Fluid Pump and Associated Fluid Pump

(75) Inventor: Wolfgang Schuller, Cleebronn (DE)

(73) Assignee: Robert Bosch GmbH, Stuttgart (DE)

(21) Appl. No.: 13/171,413

(22) Filed: Jun. 28, 2011

(30) Foreign Application Priority Data
Jun. 29, 2010 (DE) 102010030626.6

(51) Int. Cl. F16F 7/00; F16F 3/02; F16F 3/08

(52) U.S. Cl. 415/119; 267/141

(57) ABSTRACT

A pulsation damper element for a fluid pump with an elastic diaphragm and a fluid pump having such a pulsation damper element is disclosed. A pot-shaped diaphragm carrier with an elastic region is provided, the elastic diaphragm being introduced, fluid-tight, into the diaphragm carrier such that latitude of movement of the elastic diaphragm in the pressure direction is limited by the movable region of the diaphragm carrier.

This application claims priority under 35 U.S.C. §119 to German patent application no. DE 10 2010 030 626.6, filed Jun. 29, 2010 in Germany, the disclosure of which is incorporated herein by reference in its entirety.

### BACKGROUND

The disclosure relates to a pulsation damper element for a fluid pump, and to an associated fluid pump having such a pulsation damper element.

Fluid pumps designed, for example, as piston pumps are used in vehicles having hydraulic or electro hydraulic vehicle brake systems preferably as recirculating pumps, in order selectively to lower or to raise brake pressure in the wheel brake cylinders, with the result that the brake pressure in the wheel brake cylinders can be regulated. Such regulation may be carried out, for example, in an antilock system (ABS), in a traction control system (ASR system), in a driving dynamics control system, etc.

A conventional piston pump is described, for example, in the laid-open publication DE 10 2007 047 417 A1 and comprises a piston subassembly, an inlet valve, an outlet valve and a cylinder. The inlet valve is usually designed as a nonreturn valve. The outlet valve is likewise designed as a spring-loaded nonreturn valve and is arranged in a cover element of the piston pump. The outlet valve is opened when pressure in a compression space is higher than spring force of an outlet valve spring acting upon an outlet valve sealing element of the outlet valve, with the result that the outlet valve sealing element is pressed out of an outlet valve seat arranged at an outlet port of the cylinder.

To reduce the pressure pulsations, conventional piston pumps may be equipped with a pulsation damper element which has a diaphragm composed of rubber or is designed as a rubber/steel part.

### SUMMARY

The pulsation damper element according to the disclosure has, by contrast, the advantage that, due to the proposed type of construction, pressure peaks can be optimally absorbed in a small construction space, so that pressure pulsations can advantageously be reduced both in the low-pressure range and in the high-pressure range. The elastic diaphragm is deformed even at very low pressures and therefore also responds quickly and accurately even in the event of slight pressure pulsations. However, on account of the diaphragm carrier having the elastic region, the elastic diaphragm can also hold its own in the high-pressure range in terms of strength/fatigue strength, the elastic region being designed optimally for the absorption of high pressure pulsations. Overall, a small installation space and cost-effective and simple production of the pulsation damper element according to the disclosure are advantageously achieved.

A pulsation damper element according to the disclosure for a fluid pump comprises a pot-shaped diaphragm carrier with an elastic region, the elastic diaphragm being introduced, fluid-tight, into the diaphragm carrier such that latitude of movement of the elastic diaphragm in the pressure direction is limited by the movable region of the diaphragm carrier.

The pulsation damper element according to the disclosure may, for example, be installed in a pump casing and/or in a cover, preferably in an outlet valve cover, of a fluid pump.

Advantageous improvements to the pulsation damper element specified in the independent patent Claim 1 are possible as a result of the measures and developments listed in the dependent Claims.

It is especially advantageous that the elastic diaphragm is designed such that pressure pulsations in the low-pressure range can be absorbed, the absorption range of the elastic diaphragm being determined by the latitude of movement between an initial position and when the said elastic diaphragm comes to bear against the movable region of the diaphragm carrier. By contrast, the elastic region of the pot-shaped diaphragm carrier is designed such that pressure pulsations in the high-pressure range can be absorbed, the absorption range of the elastic region being determined by latitude of movement between an initial position and when the said elastic region comes to bear against a stop. In this case, the absorption of pressure pulsations by the elastic region of the diaphragm carrier commences when the elastic diaphragm comes to bear against the elastic region of the diaphragm carrier. By the elastic diaphragm coming to bear against the moveable region of the diaphragm carrier, damage to the diaphragm can advantageously be avoided in the event of higher pressure peaks which are absorbed essentially by the movable region of the diaphragm carrier, the elastic diaphragm being designed such that it can also bridge the latitude of movement of the movable region of the diaphragm carrier without risk of damage. The elastic diaphragm can nevertheless optimally absorb small pressure peaks up to the point when it comes to bear against the movable region. In the installed state, the latitude of movement of the elastic region of the diaphragm carrier is limited, for example, by the pump casing and/or a cover of the fluid pump.

In an advantageous refinement of the pulsation damper element according to the disclosure, the elastic diaphragm is designed as a flat dish with at least one injected-around spring wire core. The elastic diaphragm may, for example, have at least one spring wire ring injected around with a compound or a spring wire coil injected around with a compound, the compound being a plastic, preferably an ethylene/propylene/diene monomer. If a plurality of spring wire circles are used, a plurality of different wire thicknesses may also be used. Elastic behavior of the diaphragm can advantageously be stipulated by the number of spring wire rings and/or the wire thicknesses and/or the spacing between the spring wire rings or the turns of the spring wire coil.

In a further advantageous refinement of the pulsation damper element according to the disclosure, the elastic diaphragm has at the margin a peripheral sealing bead which seals off with respect to the diaphragm carrier and makes it possible to mount the diaphragm in a simple way and which can assume a certain latching function during introduction into the diaphragm carrier.

In a further advantageous refinement of the pulsation damper element according to the disclosure, the pot-shaped diaphragm carrier has outwardly curved side walls with a peripheral projecting margin, which together form a reception region for the elastic diaphragm, the elastic region being formed by a bottom of the diaphragm carrier. In order to improve the movability of the elastic region, the elastic region may have a perforation and/or be designed as a corrugated sheet. Overall, the diaphragm carrier may be formed from sheet metal and/or be injection-molded from plastic.

Advantageous embodiments of the disclosure are illustrated in the drawings and are described below. In the drawings, the same reference symbols designate components or elements which perform identical or similar functions.

### BRIEF DESCRIPTION OF THE DRAWINGS

FIG. 1 shows a diagrammatic sectional illustration of a pulsation damper element according to the disclosure.

FIG. 2 shows a diagrammatic top view of a detail of a first exemplary embodiment of the pulsation damper element according to the disclosure from FIG. 1.

FIG. 3 shows a diagrammatic top view of a detail of a second exemplary embodiment of the pulsation damper element according to the disclosure from FIG. 1.

### DETAILED DESCRIPTION

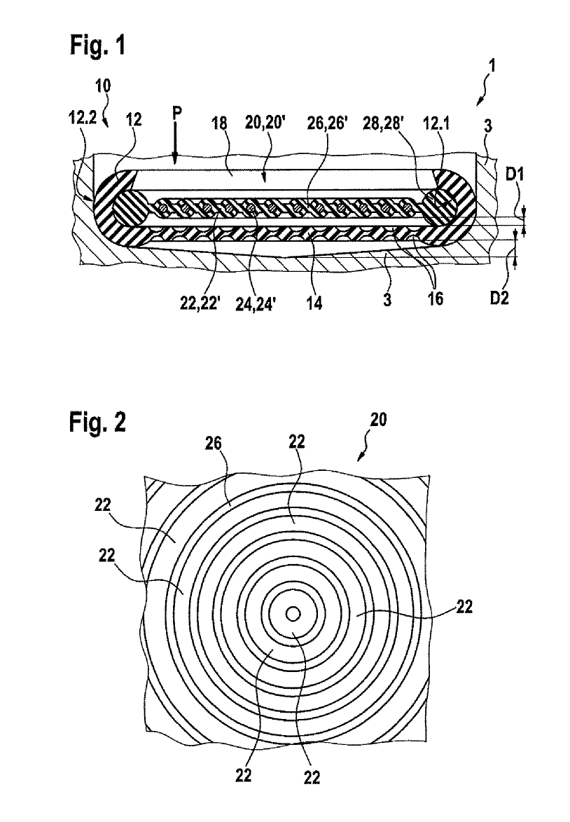

As is evident from FIG. 1, a pulsation damper element 1 according to the disclosure for a fluid pump comprises a pot-shaped diaphragm carrier 10 with an elastic region 14 and an elastic diaphragm 20, 20′. According to the disclosure, the elastic diaphragm 20, 20′ is introduced, fluid-tight, into the diaphragm carrier 10 such that latitude of movement D1 of the elastic diaphragm 20, 20′ in the pressure direction P is limited by the movable region 14 of the diaphragm carrier 10. The elastic diaphragm 20, 20′ is designed such that pressure pulsations in the low-pressure range can be absorbed, the absorption range of the elastic diaphragm 20, 20′ being determined by the latitude of movement D1 between an initial position and when the said elastic diaphragm comes to bear against the movable region 14 of the diaphragm carrier 10. The elastic region 14 of the pot-shaped diaphragm carrier 10 is designed such that pressure pulsations in the high-pressure range can be absorbed, the absorption range of the elastic region 14 being determined by latitude of movement D2 between an initial position and one as said elastic region comes to bear against a stop 3 which is formed here by a pump casing or a cover for the outlet valve of the fluid pump. The absorption of pressure pulsations by the elastic region 14 of the diaphragm carrier 10 commences when the elastic diaphragm 20, 20′ comes to bear against the elastic region 14. The elastic diaphragm is therefore designed such that it can also bridge the latitude of movement D2 of the movable region 14 of the diaphragm carrier 10 without risk of damage.

As is further evident from FIG. 1, the pot-shaped diaphragm carrier 10 has outwardly curved side walls 12 with a peripheral projecting margin 18, which together form a reception region for the elastic diaphragm 20, 20′, the elastic region 14 being formed by a bottom of the diaphragm carrier 10. In the exemplary embodiment illustrated, the bottom designed as the elastic region 14 has a perforation 16 in order to improve movability. Alternatively, the bottom may be designed as a corrugated sheet in order to improve movability. The curved side walls 12 have an inner sealing region 12.1 at which sealing off takes place with respect to the elastic diaphragm 20, 20′ introduced, which has a peripheral sealing bead 28, 28′ at the margin for this purpose, and an outer sealing region 12.2 at which sealing off takes place with respect to the pump casing 3 and/or the pump cover.

As is further evident from FIGS. 1 to 3, the elastic diaphragm 20, 20′ is designed as a flat dish with injected-around spring wire cores 24, 24′.

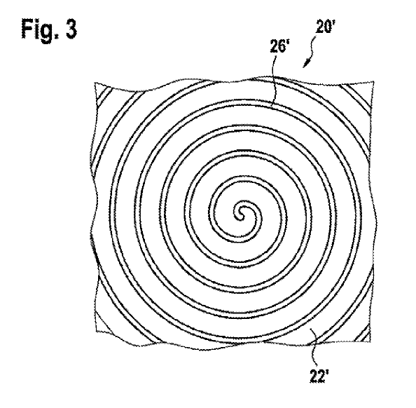

In a first exemplary embodiment according to FIGS. 1 and 2, the elastic diaphragm 20 has a plurality of spring wire rings 22 which are injected-around with a compound and are in each case connected to one another via interspaces 26 filled with the same compound. In the exemplary embodiment illustrated, the spring wire cores 24 of the individual injected-around spring wire rings 22 have the same diameter. In an alternative embodiment, not illustrated, spring wire rings having different wire thicknesses may be used.

In a second exemplary embodiment according to FIGS. 1 and 3, the elastic diaphragm 20′ has a spring wire coil 22′ which is injected-around with a compound at the interspaces 26′ of which are likewise filled with a compound. The injection compound used in both exemplary embodiments is a plastic, preferably an ethylene/propylene/diene monomer, which has suitable elastic properties. The elastic behavior of the diaphragm 20, 20′ can advantageously be stipulated by the number of spring wire rings 22 and/or the wire thicknesses and/or the spacing 26, 26′ which is/are between the spring wire rings 22 or the turns of the spring wire coil 22′.

Embodiments of the present disclosure reduce the pressure pulsations, both in the low-pressure range and in the high-pressure range, by using an elastic diaphragm and a diaphragm carrier with a movable region. In the event of slight pulsations, the elastic diaphragm responds quickly and accurately, while the movable region of the diaphragm carrier responds in the high-pressure range and protects the elastic diaphragm against damage. Pressure peaks can thus be optimally absorbed in small construction space directly in the pump or outside it. Owing to the type of construction of the elastic diaphragm, the latter is deformed at very low pressures, but can also hold its own in the high-pressure range in terms of strength/fatigue strength.

What is claimed is:

1. A pulsation damper element for a fluid pump, comprising:
an elastic diaphragm having a movable region; and
a pot-shaped diaphragm carrier with an elastic region, the elastic diaphragm being introduced, fluid-tight, into the diaphragm carrier such that latitude of movement of the elastic diaphragm in a pressure direction is limited by the movable region of the diaphragm carrier.

2. The pulsation damper element according to claim 1, wherein the elastic diaphragm is configured such that pressure pulsations in the low-pressure range can be absorbed, the absorption range of the elastic diaphragm being determined by the latitude of movement between an initial position and when the elastic diaphragm comes to bear against the movable region of the diaphragm carrier.

3. The pulsation damper element according to claim 1, wherein the elastic region of the pot-shaped diaphragm carrier is configured such that pressure pulsations in the high-pressure range can be absorbed, the absorption range of the elastic region being determined by latitude of movement between an initial position and when the said elastic region comes to bear against a stop.

4. The pulsation damper element according to claim 3, wherein the absorption of pressure pulsations by the elastic region of the diaphragm carrier commences when the elastic diaphragm comes to bear against the elastic region.

5. The pulsation damper element according to claim 1, wherein the elastic diaphragm is configured as a flat dish with at least one injected-around spring wire core.

6. The pulsation damper element according to claim 5, wherein the elastic diaphragm has at least one spring wire ring injected around with a compound or a spring wire coil injected around with a compound, the compound being a plastic.

7. The pulsation damper element according to claim 1, wherein the elastic diaphragm has at the margin a peripheral sealing bead which seals off with respect to the diaphragm carrier.

8. The pulsation damper element according to claim 1, wherein the pot-shaped diaphragm carrier has outwardly curved side walls with a peripheral projecting margin, which together form a reception region for the elastic diaphragm, the elastic region being formed by a bottom of the diaphragm carrier.

9. The pulsation damper element according to claim 8, wherein the elastic region is configured with a perforation.

10. A fluid pump, comprising:
a pump casing; and
a pulsation damper element installed in the pump casing, the pulsation damper including:
an elastic diaphragm having a movable region; and
a pot-shaped diaphragm carrier with an elastic region, the elastic diaphragm being introduced, fluid-tight, into the diaphragm carrier such that latitude of movement of the elastic diaphragm in a pressure direction is limited by the movable region of the diaphragm carrier.

11. The pulsation damper element according to claim 6, wherein the plastic is one of an ethylene or propylene or diene monomer.

12. The pulsation damper element according to claim 8, wherein the elastic region is configured as a corrugated sheet.

13. A fluid pump, comprising:
a cover; and
a pulsation damper element installed in the cover, the pulsation damper including:
an elastic diaphragm having a movable region; and
a pot-shaped diaphragm carrier with an elastic region, the elastic diaphragm being introduced, fluid-tight, into the diaphragm carrier such that latitude of movement of the elastic diaphragm in a pressure direction is limited by the movable region of the diaphragm carrier.
